(19) United States
(12) Patent Application Publication
(10) Pub. No.: US 2019/0313601 A1
(43) Pub. Date: Oct. 17, 2019

(54) PET BED

(71) Applicant: Faye Angevine, Taipei (TW)

(72) Inventor: Faye Angevine, Taipei (TW)

(21) Appl. No.: 16/382,063

(22) Filed: Apr. 11, 2019

Related U.S. Application Data
(60) Provisional application No. 62/656,618, filed on Apr. 12, 2018.

(51) Int. Cl. A01K 1/035

(52) U.S. Cl. CPC A01K 1/0353

(57) ABSTRACT

A pet bed comprises a first layer configured for retaining a filler material, a second layer surrounding the first inner layer and a third layer surrounding the second layer. The second inner layer comprises a waterproof shell so that liquid cannot contact the first inner layer if the second outer layer is exposed to a liquid. The third layer forms a second shell and is formed from a breathable fabric. The third layer can absorb liquid that may come into contact with the third layer. The second and third layers are selectively securable and removable from the first layer.

### CROSS-REFERENCE TO RELATED APPLICATION

The present application claims priority to U.S. Provisional Patent Application Ser. No. 62/656,618 filed on Apr. 12, 2018, the entirety of which is incorporated by this reference.

### BACKGROUND

### Field of the Invention

The present invention relates generally to a pet bed comprised of multiple layers. More specifically, the present invention relates to a multi-layered pet bed where each layer can be removed and separately cleaned while protecting the filler material.

### State of the Art

Pet beds, such as dog beds, are available in a variety of sizes and shapes. A typical pet bed is comprised of an outer fabric cover surrounding a filler material. For cleaning purposes, such prior art pet beds do not allow for removal of the outer cover and thus require washing of the entire pet bed, including the filler material. Not only are such pet beds difficult to launder due to their size and bulkiness, once laundered, such pet beds are difficult to dry since all of the filler material has become wet during the washing process. In some cases, especially in humid locations, the filler material can grow mold and mildew, which is harmful to animals that then utilize the pet bed.

As a result, there exists a need in the art to provide a pet bed that can be easily laundered. When a dog becomes ill or has physical limitations that may prevent it from moving to a location where the animal can relieve itself, frequent washing of the pet bed is necessary. Washing the entire pet bed each time it is soiled is not only impractical, but can be extremely energy consumption intensive to both fully wash the pet bed and to dry it. The present invention solves the aforementioned problems by providing a multi-layer pet bed that can be easily and frequently laundered.

These and further features and advantages of the present invention may be more readily appreciated when considering the following disclosure and appended claims.

### SUMMARY OF THE INVENTION

The present invention relates to a pet bed comprised of a plurality of layered covers including a first inner layer configured for retaining a filler material and a second inner layer configured for surrounding the first inner layer. The second inner layer is comprised of a waterproof material so that liquid cannot contact the first inner layer if the second outer layer gets wet. The second inner layer forms a shell that has a closure device, such as a zipper or hook and loop fastener tape, that allows the second inner layer to be removable from the first inner layer. A third layer forms an outer shell that is formed from a breathable fabric. The third layer form is configured to absorb fluid that come into contact with the outer layer. The third layer includes a closure device, such as a zipper or hook and loop fastener tape, that allows the third outer layer to be removable from the second inner layer.

In one embodiment, a pet bed comprises a first fabric layer forming a first inner shell and a resilient compressible filler material disposed within the first fabric layer. The first fabric layer permanently retains the compressible filler material therein. The first fabric layer and compressible filler material forms a cushion. A second fabric layer forms a second inner shell and completely encases, and has a similar shape and size as, the first fabric layer. The second fabric layer is comprised of a waterproof fabric so that a liquid contacting the second fabric layer is prevented from contacting the first fabric layer. The second inner layer has a first closure device for closing a first opening extending along one side thereof to allow the second inner layer to be removable from the first inner layer. A third fabric layer forms an outer shell formed from a breathable and liquid absorbing fabric and completely encasing and having a similar shape and size as the second fabric layer. The third layer is configured to absorb the liquid that may come into contact with the third layer. The third layer has a second closure device for closing a second opening extending along one side of the third layer to allow the third layer to be removable from the second layer.

In another embodiment, the first fabric layer comprises a first upper cover portion sewn completely around its perimeter to a perimeter of a first lower cover portion.

In another embodiment, the first fabric layer is sewn to the second fabric layer by a plurality of cross-stitches that extend through the compressible filler material to hold the compressible filler material in position between the first upper cover portion and the lower cover portion.

In yet another embodiment, the cushion has a thickness that is less than its width or length so as to form a relatively flat resting surface.

In still another embodiment, the first fabric layer is comprised of a breathable fabric.

In another embodiment, the filler material is comprised of a filament polyester.

In yet another embodiment, the upper and lower cover portions are connected by seams on all four sides so as to permanently contain the filler material therein.

In another embodiment, the second fabric layer comprises a second upper cover portion sewn to a second lower cover portion, the second upper and lower cover portions forming a pouch within which cushion resides.

In yet another embodiment, the second fabric layer protects the first fabric layer from exposure to liquid to which the second fabric layer is exposed.

In still another embodiment, the second fabric layer comprises a breathable, waterproof, dual-layer material.

In yet another embodiment, the dual-layer material comprises a polyester fabric covered by a thermoplastic polyurethane laminate lining.

In another embodiment, the first closure device comprises a zipper extending along a length of one side of the first opening of the second fabric layer.

In yet another embodiment, the second closure device comprises a zipper extending along a length of one side of the second opening of the third fabric layer.

In still another embodiment, a fabric flap extends from the second opening of the third fabric layer and covers an entire length of the zipper to prevent the zipper from being exposed to an animal resting on the pet bed.

In still another embodiment, the first closure device comprises a plurality of sections of hook and loop fastener tape attached on opposite sides of the first opening, open end portions of the second fabric layer at the second opening being to form an effective seal against penetration of liquid to an inside of the second fabric layer.

In yet another embodiment, the third fabric layer is comprised of a cotton and polyester fabric blend of 35% to 40% cotton and 60% to 65% polyester.

In still another embodiment, the cotton and polyester fabric blend has a higher percentage of cotton in warmer environmental conditions.

### BRIEF DESCRIPTION OF THE DRAWINGS

The following detailed description of the illustrated embodiments is better understood when read in conjunction with the appended drawings. For the purpose of illustrating the invention, there is shown in the drawings exemplary embodiments which illustrate what is currently considered to be the best mode for carrying out the invention, it being understood, however, that the invention is not limited to the specific methods and instruments disclosed. In the drawings:

FIG. 1 is a perspective view of the pet bed in accordance with the principles of the present invention.

FIG. 2 is a cross-sectional view of the pet bed shown in FIG. 1.

FIG. 3 is a perspective view of a first inner layer of the pet bed in accordance with the principles of the present invention.

FIG. 4 is a perspective view of a second inner layer of the pet bed in accordance with the principles of the present invention.

FIG. 5 is a perspective view of an outer layer of the pet bed in accordance with the principles of the present invention.

FIG. 6 is a perspective view of the outer layer of the pet bed shown in FIG. 1 in a closed configuration.

### DETAILED DESCRIPTION OF THE INVENTION

Novel features which are characteristic of the invention, as to organization and method of operation, together with further objects and advantages thereof will be better understood from the following description considered in connection with the accompanying drawings, in which embodiments of the invention are illustrated by way of example. It is to be expressly understood, however, that the drawings are for illustration description only and are not intended as definitions of the limits of the invention. The various features of novelty that characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. Thus, the full scope of the invention is not limited to the examples that are described below.

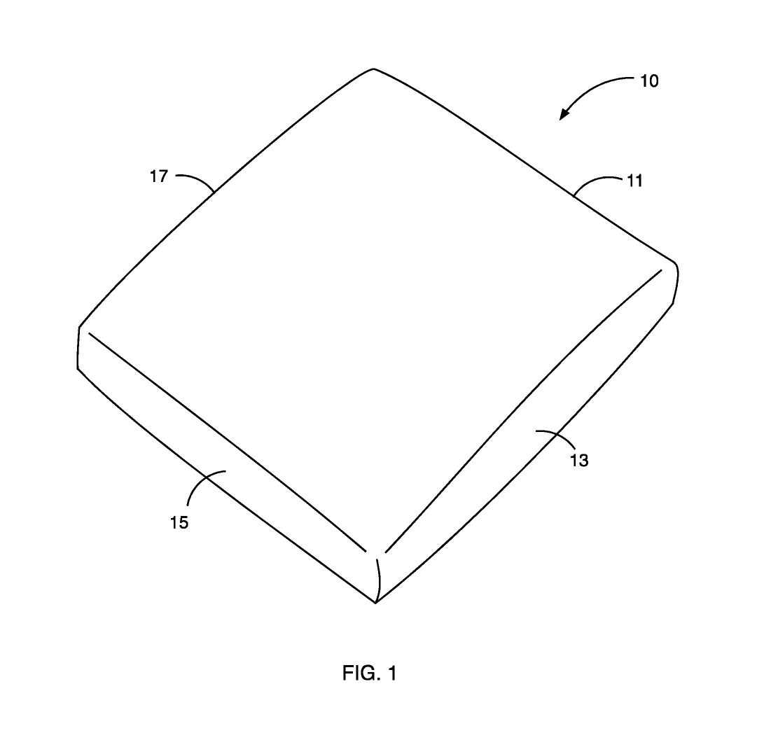

Referring to FIG. 1, a pet bed, generally indicated at 10, is disclosed for facilitating resting and sleeping of a pet, such as a dog. The pet bed 10 can be manufactured in a number of sizes, such as small, medium, large and extra-large, depending on the size of animal that may use the pet bed. The pet bed 10, as illustrated in FIG. 1, is a generally rectangularly shaped cushion having four sides 11, 13, 15 and 17 upon which a pet can rest or sleep. The pet bed 10 has a thickness that is less than its width or length so as to form a relatively flat resting surface for the animal. Of course, the shape of the pet bed 10 can be configured to have any geometric shape, such as circular, oval or any other desired shape. A rectangularly shaped pet bed 10 has the advantage of being simple to manufacture and, as will be described in more detail, comprised of a number of separately washable layers.

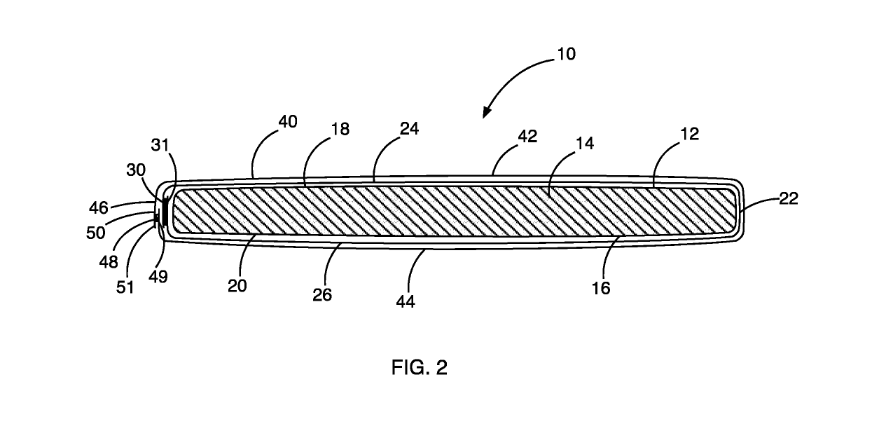

As shown in cross-section in FIG. 2, the pet bed 10 is comprised of a three-layer system. The first inner layer 12 comprises a resilient, compressible filler material 14 that is surrounded by a first shell material 16 comprised of upper and lower cover portions 18 and 20, respectively. The first shell material 16 may be a breathable fabric, such as cotton, polyester or other materials known in the art capable of retaining the filler material 14. A polyester fabric may be employed for the upper and lower cover portions 18 and 20, respectively. Such a polyester fabric is durable while retaining breathability characteristics. The filler material may be a foam pad or foam chunks, such as open cell foam, closed cell foam or memory foam, batting, filament polyester, feather, down or straw-type filler material. Filament polyester has particular applicability as it is relatively inexpensive while retaining good resiliency characteristics over time and repeated use. The upper and lower covers 18 and 20 encase the filler material to establish the shape and size of the pet bed 10. The upper and lower cover portions 18 and 20 are connected by seams on all four sides so as to permanently contain the filler material 14 therein to form an inner cushion. The inner cushion is of a lightweight construction with sufficient thickness to provide a comfortable resting place for an animal.

The second inner layer 22 comprises a waterproof material that forms a cover over and around the first inner layer 12. The second layer 22 comprises a shell having upper and lower cover portions 24 and 26, respectively. The upper and lower covers 24 and 26 form a pouch within which the first inner layer 12 can reside. The second inner layer 22 protects the first inner layer from moisture to which the second inner layer 22 may be exposed. The second inner layer may be formed from any waterproof or highly water-resistant fabric material, such as stretched polytetrafluoroethylene (PTFE) sold under the trademark GOR-TEX™ or a fabric with a waterproof lining. A dual-layer fabric with a waterproof lining has particular applicability. The waterproof lining of the present invention is comprised of a breathable laminate fabric that is breathable to allow a flow of air without allowing liquids to absorb through the fabric. The waterproof lining is comprised of a polyester fabric with a thermoplastic polyurethane laminate lining. The thermoplastic polyurethane laminate lining allows the polyester fabric to remain breathable while preventing liquid from penetrating the polyester fabric. Such a fabric also resists dust mites, mold and bacteria from forming on the fabric as it has an antibacterial/anti-fungal effect. In addition, such a fabric is machine washable As such, a fabric comprising natural or synthetic fabrics that are laminated to or coated with waterproofing materials such as rubber, polyvinyl chloride (PVC), polyurethane (PU), silicone elastomer, fluoropolymers or other materials known in the art that provide for breathability while remaining waterproof are of particular applicability.

The upper and lower covers 24 and 26 are joined on three sides by seams. The fourth longitudinal side 28 of the second inner layer 22 is open to allow removal and replacement of the first inner layer 12. This allows the second layer to be cleaned separately from the first inner layer 12. The selectively openable end 30 of the second inner layer 22 is provided with a closure device 31, such as a zipper or one or more sections of hook and loop fastener tape. When using hook and loop fastening tape, edges of the openable end 30 of the second inner layer 22 can be overlapped to provide an effective seal against penetration of liquid to the inside of the second inner layer 22 and thus prevents such liquid from contacting the first inner layer 12.

The third outer layer 40 comprises a breathable fabric material that forms a cover over and around the first and second inner layers 12 and 22. The third outer layer 40 comprises a shell having upper and lower cover portions 42 and 44, respectively. The upper and lower cover portions 42 and 44 form a pouch within which the first and second inner layers 12 and 22 can reside. The third outer layer 40 protects absorbs any liquid that it may come into contact with the third outer layer 40. In addition, because the third outer layer 40 is breathable, it provides a buffer or insulative layer between the second inner layer 22 and an animal resting on the pet bed 10 to prevent or reduce physical and thermal discomfort to the animal that could otherwise occur if the animal were to rest directly against the second inner layer 22 as a result of its waterproof or water resistant properties. The third outer layer 40 may be formed from any breathable fabric, such as cotton, polyester or blends thereof or any other breathable fabrics known in the art. In particular, the outer layer 40 may provide covers that are different depending on the season or climate. For example, for cooler climates or winter months, a fabric comprising 35% cotton and 65% polyester, formed as a fleece or flannel fabric, can provide added warmth for an animal resting on the pet bed 10. For warmer climates or summer, early fall or late spring months, a fabric comprising 40% cotton and 60% polyester, formed as a less dense fabric to provide an added cooling effect for an animal resting on the pet bed is desirable. Thus, such breathable fabrics may comprise any natural or synthetic fabrics in ratios to provide the desired fabric characteristics depending on environmental conditions. In addition, the outer cover fabric may be provided in an assortment of fashion patterns and are fully machine washable.

The upper and lower cover portions 42 and 44 are joined on three sides by seams. The fourth longitudinal side 46 of the third outer layer 22 defines a selectively openable end 48 to allow removal and replacement of the first and second inner layers 12 and 22. The openable end 48 of the third outer layer 40 is provided with a closure device 49, such as a zipper or one or more sections of hook and loop fastener tape. When using a zipper, the outer edge portion 51 of the openable end 48 forms a flap 50 that covers the closure device 49 to prevent the animal from chewing the closure device 49.

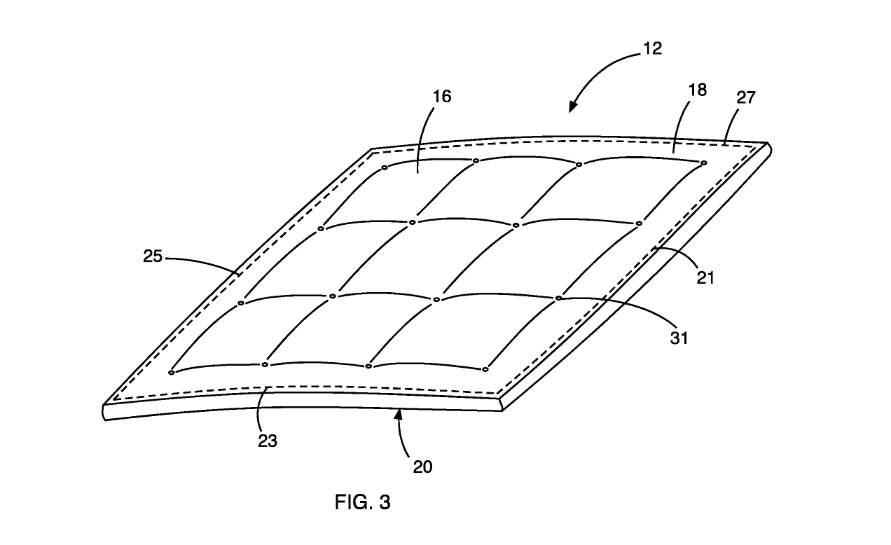

As shown in FIG. 3, the first inner layer 12 comprises a resilient, compressible filler material (not visible) that is surrounded by a first shell material 16 composed of upper and lower cover portions 18 and 20, respectively. The first shell material 16 may be a breathable fabric, such as cotton, polyester or other materials known in the art capable of retaining the filler material. The filler material may be a foam pad or foam chunks, such as open cell foam, closed cell foam or memory foam, batting, filament polyester, feather, down or straw-type filler material. The upper and lower cover portions 18 and 20 encase the filler material to establish the shape and size of the pet bed 10 (see FIG. 1). The upper and lower cover portions 18 and 20 are connected by seams, such as seams 21, 23, 25 and 27 on all four sides so as to permanently contain the filler material therein. In addition, when using a filament-type filler material, the upper and lower cover portions 18 and 20 may be joined together by point stitching or cross stitching 31 at various locations across the upper surface of the first inner layer 12. Such point stitching prevents the filler material from moving to one side or the other of the first inner layer 12 or from bunching up in a corner during washing of the first inner layer 12. Thus, the point or cross stitching 31 holds the filler material in place during use and cleaning of the first inner layer 12 so that the resulting inner cushion maintains its shape during use and washing. The spacing and quantity of such point or cross stitching 31 may vary depending on the size of the pet bed. The overall thickness of the first inner layer 12 is between about 4 cm to 6 cm to provide adequate padding for an animal resting on the pet bed, depending on the overall size of the pet bed, but not so thick as to become cumbersome or difficult for an animal to climb upon.

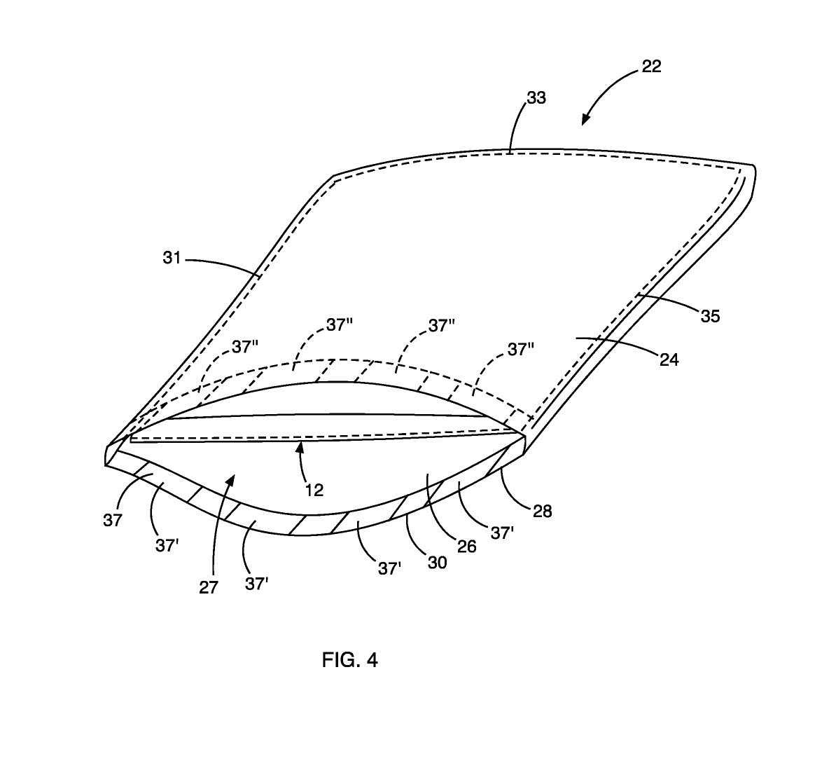

As shown in FIG. 4, the second inner layer 22 is comprised of a waterproof material that forms a cover over and around the first inner layer 12. The second layer 22 comprises a shell having upper and lower covers 24 and 26, respectively. The upper and lower covers 24 and 26 form a pouch 27 within which the first inner layer 12 can reside. The second inner layer 22 protects the first inner layer 12 from moisture or liquid to which the second inner layer 22 may be exposed. The second inner layer 24 may be formed from any waterproof or highly water-resistant fabric materials known in the art, such as stretched polytetrafluoroethylene (PTFE) sold under the trademark GOR-TEX™. Such materials may comprise natural or synthetic fabrics that are laminated to or coated with waterproofing materials such as rubber, polyvinyl chloride (PVC), polyurethane (PU), silicone elastomer, fluoropolymers or other materials known in the art.

The upper and lower covers 24 and 26 are joined on three sides by seams 31, 33 and 35. The fourth longitudinal side 28 of the second inner layer 22 is open to allow removal and replacement of the first inner layer 12. The open end 30 of the second inner layer 22 is provided with a closure device 37, shown herein as a plurality of sections 37′ and 37″ of hook and loop fastener tape. When using hook and loop fastening tape, edges of the open end 30 of the second inner layer 22 can be overlapped to provide an effective seal against penetration of liquid to the inside of the second inner layer 22.

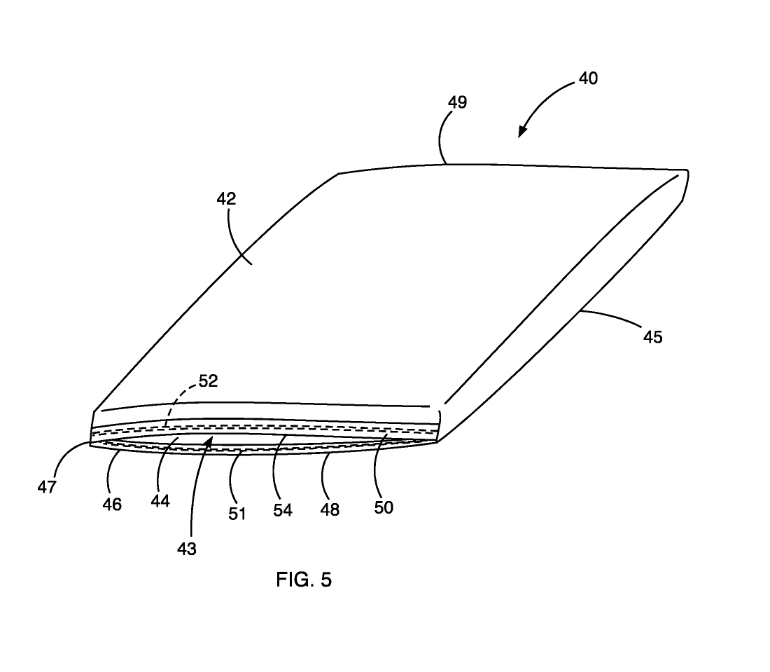

As shown in FIG. 5, the third outer layer 40 comprises a breathable fabric material that forms a cover over and around the first and second inner layers 12 and 22 (not visible). The third outer layer 40 comprises a shell having upper and lower cover portions 42 and 44, respectively. The upper and lower cover portions 42 and 44 form a pouch 43 within which the first and second inner layers 12 and 22 can reside. The third outer layer 40 protects absorbs any liquid that it may come into contact with the third outer layer 40. In addition, because the third outer layer 40 is breathable, it provides a buffer between the second inner layer 22 and the animal resting on the pet bed 10 to prevent or reduce physical and thermal discomfort to the animal that could otherwise occur if the animal were to rest directly against the second inner layer 22 as a result of its waterproof or water resistant properties. The third outer layer 40 may be formed from any breathable fabric, such as cotton, polyester or blends thereof or any other breathable fabrics known in the art. Such breathable fabrics may comprise any natural or synthetic fabrics.

The upper and lower covers 42 and 44 are joined on three sides by seams 45, 47 and 49. The fourth longitudinal side 46 of the third outer layer 22 defines a closable open end 48 to allow removal and replacement of the first and second inner layers 12 and 22. The opening 48 of the third outer layer 40 is provided with a closure device 51, such as a zipper 52. When using a zipper 52, the outer edge 54 of the opening 48 forms a flap 50 that covers the zipper to prevent the animal from chewing the zipper 52.

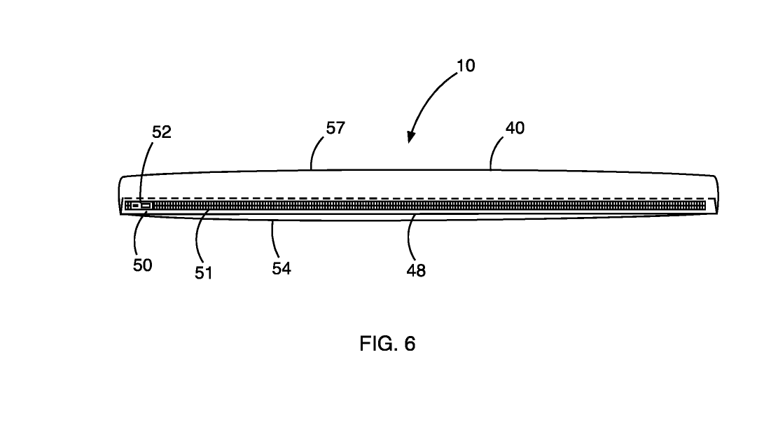

As shown in FIG. 6, when the closure device 51 is secured, the openable end 48 of the third outer layer 40 is closed. The flap 50 covers the zipper 52 so as to prevent access to the zipper 52 by an animal. That is, while the zipper 52 is shown as being visible in FIG. 6 for illustration purposes only, it actually resides behind the flap 50 that extends over the zipper 52. In addition, the zipper 52 is positioned proximate the bottom side 55 of the pet bed 10 to further limit access to the zipper 52 by an animal that may be resting on the top surface 57 of the pet bed 10.

The above disclosure is sufficient to enable one of ordinary skill in the art to practice the invention, and provides the best mode of practicing the invention presently contemplated by the inventor. While there is provided herein a full and complete disclosure of the best mode of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

It is contemplated, and will be apparent to those skilled in the art from the foregoing specification, drawings, and examples that modifications and/or changes may be made in the embodiments of the invention. Accordingly, it is expressly intended that the foregoing are only illustrative of preferred embodiments and modes of operation, not limiting thereto, and that the true spirit and scope of the present invention be determined by reference to the appended claims.

While the present invention has been described with reference to certain illustrative embodiments to illustrate what is believed to be the best mode of the invention, it is contemplated that upon review of the present invention, those of skill in the art will appreciate that various modifications and combinations may be made to the present embodiments without departing from the spirit and scope of the invention as recited in the claims. The claims provided herein are intended to cover such modifications and combinations and all equivalents thereof. Reference herein to specific details of the illustrated embodiments is by way of example and not by way of limitation.

Thus, aspects and applications of the invention presented here are described in the drawings and in the foregoing detailed description of the invention. Those of ordinary skill in the art will realize that the description of the present invention is illustrative only and not in any way limiting. Other embodiments of the invention will readily suggest themselves to such skilled persons including, without limitation, combinations of elements of the various embodiments. Various representative implementations of the present invention may be applied to any valve.

Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use the plain and ordinary meaning of terms in the specification and claims unless they clearly state otherwise in which case, the inventor will set forth the “special” definition of that term and explain how it differs from the plain and ordinary meaning. Absent such statements of the application of a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description of the Invention or claims is not intended to somehow indicate a desire to invoke the special provisions of 35 U.S.C. § 112(f) to define the invention. To the contrary, if the provisions of 35 U.S.C. § 112(f) are sought to be invoked to define the inventions, the claims will specifically and expressly state the exact phrases “means for” or “step for” and the specific function (e.g., “means for heating”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

What is claimed is:

1. A pet bed, comprising:
a first fabric layer forming a first inner shell;
a resilient compressible filler material disposed within the first fabric layer, the first fabric layer permanently retaining the compressible filler material therein, the first fabric layer and compressible filler material forming a cushion;
a second fabric layer forming a second inner shell and completely encasing, and having a similar shape and size as, the first fabric layer, the second fabric layer comprised of a waterproof fabric so that a liquid contacting the second fabric layer is prevented from contacting the first fabric layer, the second inner layer having a first closure device for closing a first opening extending along one side thereof to allow the second inner layer to be removable from the first inner layer; and
a third fabric layer forming an outer shell formed from a breathable and liquid absorbing fabric and completely encasing and having a similar shape and size as the second fabric layer, the third layer configured to absorb the liquid that may come into contact with the third layer, the third layer having a second closure device for closing a second opening extending along one side of the third layer to allow the third layer to be removable from the second layer.

2. The pet bed of claim 1, wherein the first fabric layer is comprised of a first upper cover portion sewn completely around its perimeter to a perimeter of a first lower cover portion.

3. The pet bed of claim 2, wherein the first fabric layer is sewn to the second fabric layer by a plurality of cross-stitches that extend through the compressible filler material to hold the compressible filler material in position between the first upper cover portion and the lower cover portion.

4. The pet bed of claim 1, wherein the cushion has a thickness that is less than its width or length so as to form a relatively flat resting surface.

5. The pet bed of claim 1, wherein the first fabric layer is comprised of a breathable fabric.

6. The pet bed of claim 5, wherein the filler material is comprised of a filament polyester.

7. The pet bed of claim 2, wherein the upper and lower cover portions are connected by seams on all four sides so as to permanently contain the filler material therein.

8. The pet bed of claim 1, wherein the second fabric layer comprises a second upper cover portion sewn to a second lower cover portion, the second upper and lower cover portions forming a pouch within which cushion resides.

9. The pet bed of claim 8, wherein the second fabric layer protects the first fabric layer from exposure to liquid to which the second fabric layer is exposed.

10. The pet bed of claim 1, wherein the second fabric layer comprises a breathable, waterproof, dual-layer material.

11. The pet bed of claim 10, wherein the dual-layer material comprises a polyester fabric covered by a thermoplastic polyurethane laminate lining.

12. The pet bed of claim 1, wherein the first closure device comprises a zipper extending along a length of one side of the first opening of the second fabric layer.

13. The pet bed of claim 1, wherein the second closure device comprises a zipper extending along a length of one side of the second opening of the third fabric layer.

14. The pet bed of claim 13, further comprising a fabric flap extending from the second opening of the third fabric layer and covering an entire length of the zipper to prevent the zipper from being exposed to an animal resting on the pet bed.

15. The pet bed of claim 1, wherein the first closure device comprises a plurality of sections of hook and loop fastener tape attached on opposite sides of the first opening, open end portions of the second fabric layer at the second opening being to form an effective seal against penetration of liquid to an inside of the second fabric layer.

16. The pet bed of claim 1, wherein the third fabric layer is comprised of a cotton and polyester fabric blend of 35% to 40% cotton and 60% to 65% polyester.

17. The pet bed of claim 16, wherein the cotton and polyester fabric blend has a higher percentage of more cotton in warmer environmental conditions.
